(19) United States
(12) Patent Application Publication
(10) Pub. No.: US 2004/0041460 A1
(43) Pub. Date: Mar. 4, 2004

(54) Mud cover

(76) Inventor: Eugene L. Mosher, Owatonna, MN (US)

Correspondence Address: Carl L. Johnson, Jacobson and Johnson, Suite 285, One West Water Street, St. Paul, MN, 55107-2080, US

(21) Appl. No.: 10/233,945

(22) Filed: Sep. 3, 2002

(51) Int. Cl. B60B 7/00

(52) U.S. Cl. 301/37.101

(57) ABSTRACT

A bowl shaped member having a peripheral edge for positioning proximate a wheel rim to prevent dirt from entering therebetween and a central region having a set of lug bolt openings to permit mounting the wheel cover over the axle shaft and proximate the wheel hub so that the lug bolt holds the wheel cover in a rotatable position to allow dirt and debris to fall off the wheel cover without having an opportunity to adhere to the wheel rim.

This invention relates generally to wheel covers and, more specifically, to mud covers for attachment to the inside of a rear wheel of a vehicle to prevent track material from adhering to the wheel rim and thereby cause the wheel to become unbalanced.

### CROSS REFERENCE TO RELATED APPLICATIONS

None

### STATEMENT REGARDING FEDERALLY SPONSORED RESEARCH OR DEVELOPMENT

None

### REFERENCETO A MICROFICHE APPENDIX

None

### BACKGROUND OF THE INVENTION

The concept of covers for wheels for decorative purposes as well as for preventing dirt and other materials from adhering to the cover is known in the art. In the art of dirt track racing, where the vehicles race around an oval or round track, the outer wheels of the vehicle slide radially outward due to the centrifugal force on the vehicle. As a result the track material, which is usually soil, is forced against the rims of the wheel resulting in at least some of the soil adhering to the rim causing the wheel to become unbalanced. In contrast the rear wheels experience track material impinging on the inside of the rims which when accumulated thereon can also throw the wheel out of balance and produce unwanted vibration.

While various mud covers have been proposed, the mud covers need to shed any soil that impacts thereon as well as mountable to existing wheel rims in a sufficiently securable condition to maintain the mud cover thereon as the vehicle encounters the forces and stresses produces by the tires and wheels sliding on the track. Vehicle sliding is particular acute as the vehicle races around a curved track. That is, as the vehicle circles a race track the outer wheels slide radially outward across the track causing soil on the track to impact the outer wheel rim while the rear wheels are impacted with track material on the inside of the wheel. If the soil is moist or otherwise sticky the soil can adhere to the wheel rim creating an unbalanced wheel condition on either rear or front wheels.

In my copending application Ser. No. 10/093,996 Title Mud Cover Assembly filed Mar. 11, 2002 I disclose a mud cover assembly for an exterior portion of a wheel rim with the mud cover providing interlocking engagement with the wheel rim and without the necessity to altar the wheel rim. In particular the invention is suitable for use on the exterior of front wheels of a dirt track racing vehicle or other vehicles that are driven in conditions where mud or the like can produce an unbalanced wheel condition.

In contrast to the exterior wheel cover, the present invention is a mud cover and method of making a mud cover for use on the inside of a wheel of a dirt track racing car and partially the inside rear wheel of the dirt track racing car. The cover comprises a concave bowl-like shield that mounts on the axle shaft between the rim and the hub with the shield extending out radially to inhibit dirt and debris from coming into contact with the rim.

### SUMMARY OF THE INVENTION

Briefly, the invention comprises a concave shaped member having a radially and peripheral region for positioning proximate a wheel rim to prevent dirt from entering therebetween and a central region having a set of lug bolt openings to permit mounting the wheel cover on a flanged axle shaft so that the lug bolt pressure exerted on the wheel hub and the flanged axle shaft holds the wheel cover in a rotatable position to allow dirt and debris to fall off the wheel cover without having an opportunity to adhere to the wheel rim.

### BRIEF DESCRIPTION OF THE DRAWINGS

FIG. 1 is a side view sectional of a wheel with my mud cover mounted thereon;

FIG. 2 is a sectional view taken along lines 2-2 of FIG. 1;

FIG. 3 is a layout view of my mud cover prior to formation into a concave member;

FIG. 4 is a side view of my mud cover;

FIG. 5 shows a partial detail view of radial fins with a tab securing adjacent radial fins to each other

### DESCRIPTION OF THE PREFERRED EMBODIMENT

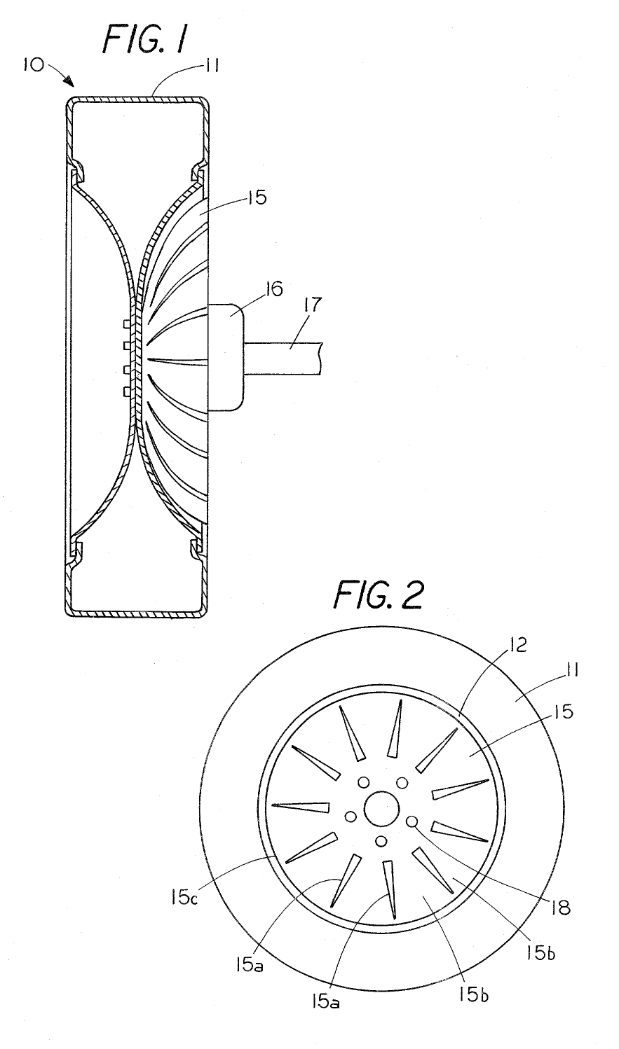

FIG. 1 is a side sectional view of a wheel assembly 10 with a tire 11 having a mud cover 15 mounted on hub 16 of axle 17. Mud cover 15 forms a bowl-like covering over a major portion on the inside of the rim to prevent debris and dirt from adhering to the rim or coming into contact with the inside of the rim.

FIG. 2 is a sectional view taken along lines 2-2 of FIG. 1 showing mud cover 15 having a peripheral edge 15c centrally positioned with respect to rim 12. A set of elongated rectangular radial slots 15a separate a set of radial fins 15b, which are located around the outer peripheral portion of the mud cover 15. Mud cover 15 includes a set of wheel stud openings 18 to permit mounting of the mud cover on the existing wheel studs without having to alter the wheel.

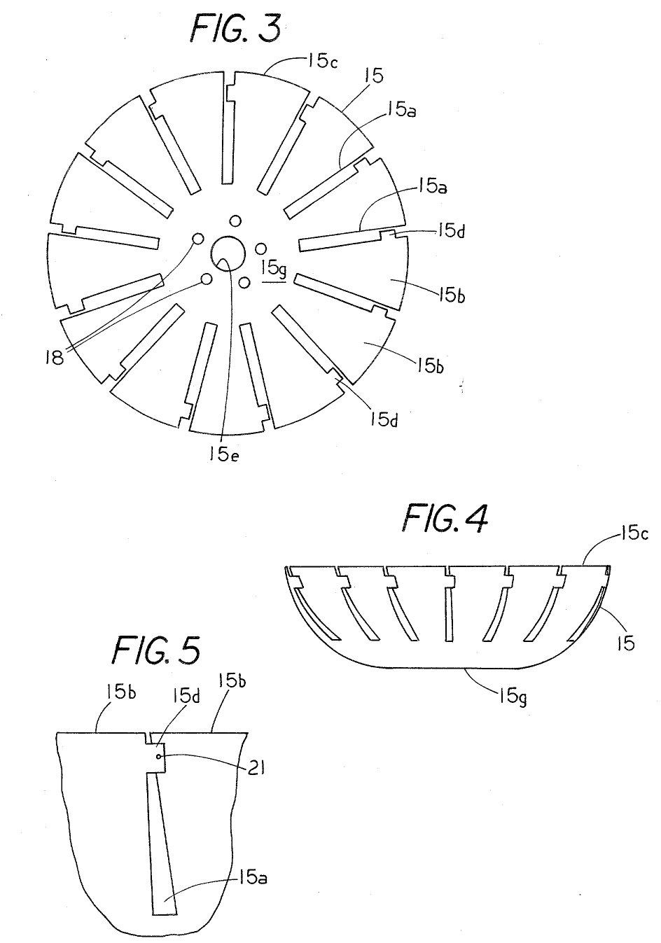

FIG. 3 shows a layout of the mud cover 15 wherein the mud cover 15 is shown in plane view and in an unformed condition. In the unformed condition a flat piece of metal of substantially uniform thickness is cut into a generally circular shape having a peripheral edge 15c with the outer radial portion of the mud cover 15 formed from a set of triangular shaped radial fins 15b that are each separated by elongated slots 15a. In the embodiment shown each of the radial fins 15b are formed with a lateral tab 15d, which is to be used to hold the radial fins 15b as an integral one-piece mud cover. The wheel stud openings 18a are located on a bolt circle in the center region 15h of the mud cover 15 and are circumferentially spaced to accommodate a particular make and model vehicle. A central opening 15e is included in mud cover 15 to provide a central relief area so the mud cover 15 can fit over a central hub protrusion found on most hubs. As can be seen in FIG. 3 the entire mud wheel cover 15 can be cut from a single piece of flat deformable material. The preferred deformable material is steel since the regions of the mud cover proximate the wheel stud act as washers and are squeezed by the lug nuts that hold the wheel hub on the axle shaft. That is the mud cover is sandwiched between the wheel hub and the axle shaft and is held in pressure engagement therebetween to permit the mud cover to rotate as the wheel rotates.

Referring to FIG. 4 the mud cover 15 shown in FIG. 3 has been formed into a concave or bowl-like member having a flat central area 15g and an upraised peripheral region bounded by a peripheral edge 15c.

A reference to FIG. 5 reveals a detail of two adjacent radial fins 15b which have been secured to each other by tab 15d. In the embodiment shown tab 15d has been spot welded to the adjacent radial fin 15b after forming a curved radius into the tab. That is, once the radial fins 15b have been bent upward as illustrated in FIG. 4 each of the tabs 15d are secured to an adjacent fin other to hold the concave or bowl-like shape to mud cover 15.

FIG. 3 illustrates that the slots 15a are generally rectangular and elongated with the tab being cut from the material between the radial fins. When the fins are bowed upward as illustrated in FIG. 4 the elongated slots decrease in size toward the edge. That is the elongated slots permit one to fold the radial fins into a bowl-like member without buckling the material since the spacing between the radial fins permits the fins 15b to altar their spacing as the fins are formed into a curved the mud cover. Consequently, one can form the bowl shape mud cover out of a single sheet of metal without introducing crimps or irregular folds into the metal through the use of radial relief areas.

Although the method of formation of a mud cover leaves elongated tapered slots in the mud cover the slots do not permit mud or dirt to enter since the mud cover rotates with the wheel thus offering minimal opportunity for dirt and debris to enter the rim. A further advantage of the present arrangement is that the slots permit air circulation to cool the brakes.

In the embodiment shown the mud cover is included with the elongated slot for the dual purpose of providing air vents in the mud cover as well as to facilitate the forming of the mud cover. In certain applications one may not need the air vents and one may not be concerned with the curved formation of the mud cover. That is, the mud cover without elongated relief slots can be formed into a concave shape through a hydraulic press deforming the mud cover within a die.

While the tabs are shown integral to the radial fins 15b it is understood that the tabs can be separately attached to adjacent fins to hold the fins in position. However, the use of integral tabs greatly simplifies the assembly process.

I claim:

1. A mud cover comprising:
a concave member, said concave member having a central attachment region with the concave member flaring radially outward toward an outer peripheral edge; and
a set of wheel stud openings, said set of wheel stud openings centrally located in said central attachment region so that when said mud cover is mounted on an axle shaft the mud cover is held in pressure engagement between a wheel and a hub on a vehicle to provide a barrier to mud contacting and adhering thereto.

2. The mud cover of claim 1 wherein the concave member includes radially slots therein.

3. The mud cover of claim 1 wherein the concave members is metal.

4. The mud cover of claim 1 wherein the concave member includes a set of radial fins with each of said radially fin secured to an adjacent radial fin.

5. The mud cover of claim 3 wherein the metal is steel.

6. The mud cover of claim 1 wherein said concave member includes a plurality of radial fins each with an integral tab for securing to an adjacent radial fin.

7. The mud cover of claim 6 where the each of the tabs are spot welded to the adjacent radial fin to maintain the mud cover shape.

8. The mud cover of claim 1 wherein the mud cover includes at least 10 radial slots therein.

9. The mud cover of claim 1 wherein the mud cover comprises a one-piece metal mud cover of substantially uniform thickness.

10. The method of making a mud cover comprising the steps of:
selecting a flat sheet of metal;
cutting the sheet of metal into a shape deformable to a bowl-like configuration;
forming a set of lug openings in a central portion of the concave member for mounting the mud cover; and
deforming an outer peripheral region of the cut sheet of metal into the bowl-like configuration.

11. The method of claim 10 including the step of cutting a set of radial fins into the peripheral region of the sheet of metal.

12. The method of claim 11 where the step of deforming comprise bending the radial fins to form a concave member.

13. The method of claim 12 including the step of forming a tab on each of the radial fins.

14. The method of claim 13 including the step of securing each of the radial fines to an adjacent fin to maintain a concave shape to the mud cover.

15. The method of claim 14 wherein the step of securing each of the radial fins includes the step of spot welding each of the radial fins to an adjacent radial fin.

16. The method of claim 15 including the step of forming the mud cover of steel.

17. The method of claim 16 including the step of forming a central opening in the mud cover.

18. The method of claim 17 including the step of securing the mud cover to a wheel hub through pressure engagement between the rim and the hub.

19. The method of claim 10 including the step of making the mud cover from a single piece of metal.
